(19) United States
(12) Patent Application Publication
(10) Pub. No.: US 2025/0069287 A1
(43) Pub. Date: Feb. 27, 2025

(54) DEVICE AND METHOD FOR COLOR CONTRAST ENHANCMENT BASED ON HUMAN COLOR VISION FEATURES

(71) Applicant: HUAWEI TECHNOLOGIES CO., LTD., Shenzhen (CN)

(72) Inventors: Nataliia Alexandrovna Obukhova, Saint Petersburg (RU); Alexander Alexandrovich Motyko, Saint Petersburg (RU); Alexandr Anatolievich Pozdeev, Saint Petersburg (RU); Evgeny Viktorovich VOROBYEV, Moscow (RU); Mikhail Konstantinovich TCHOBANOU, Moscow (RU)

(21) Appl. No.: 18/828,528

(22) Filed: Sep. 9, 2024

Related U.S. Application Data
(63) Continuation of application No. PCT/RU2022/000068, filed on Mar. 9, 2022.

(51) Int. Cl. G06T 11/00; G06F 3/0482; G06F 9/451

(52) U.S. Cl. CPC G06T 11/001; G06F 3/0482; G06F 9/451

(57) ABSTRACT

The disclosure relates to user specific color contrast enhancement. The disclosure provides a device and a corresponding method for estimating a categorical color matching function, CMF, type of a user, and/or adjusting a color imaging workflow of a device. Estimating a categorical CMF type of the user includes causing a display to show a set of binary color tests; calculating a score for each categorical CMF type of a predetermined set of categorical CMF types based on received input information; and selecting, for the user, a categorical CMF type corresponding to a largest or smallest score. Further, the disclosure provides a device and a corresponding method for creating the set of binary color tests.

### CROSS-REFERENCE TO RELATED APPLICATIONS

This application is a continuation of International Application No. PCT/RU2022/000068, filed on Mar. 9, 2022, the disclosure of which is hereby incorporated by reference in its entirety.

### TECHNICAL FIELD

This disclosure relates to user specific color contrast enhancement. The disclosure provides a device and a corresponding method for estimating a categorical color matching function type of a user and/or adjusting a color imaging workflow of a device. Further, the disclosure provides a device and a corresponding method for creating a set of binary color tests.

### BACKGROUND

Color contrast is one of the main properties of an image, affecting the perception of an observer and a subjectively perceived quality of the image. The observer metamerism effect describes the fact that the same light may produce different perceptions of color for different observers. Currently the color imaging workflow of devices is typically based on the color matching functions (CMFs) of a predefined single standard observer, wherein it is assumed that all observer possess the same color vision features. However, the color vision features, and thus the optimal CMFs, differ from person to person.

Historically, these differences were considered negligible, and thus dismissed for the optimization of devices. However, modern devices are developed with a wider color gamut. Thus, ignoring the individual characteristics of human color vision can lead to a modified or distorted color contrast and a drop in the perceived image quality.

To achieve wide color gamut, it is necessary to realize very narrow spectral power density (SPD) functions—also referred to as ‘display primaries’—of a display. However, narrower display SPD functions may lead to a modified or distorted color contrast, due to a more pronounced metameric failure effect, because of the variability of individual characteristics of each person's CMFs. For example, the color contrast may be decreased.

To decrease the metameric failure, conventional procedures for personalized color imaging include the grouping of observers into categorical observer types, and determining, for a user, a type of categorical observer with pseudoisochromatic images. However, the pseudoisochromatic images have strict requirements and have to be displayed on special displays with a large number of display primaries (at least 9 to 13 theoretical primaries). Further, only a limited number of categorical observer types may be distinguishable.

Other conventional procedures include controlling an image display device to allow the same perception of colors and color contrast over a large variety of observers, or using other special devices, for example, a nomaloscope.

In summary, however, the conventional procedures to decrease metameric failure require quite specialized hardware.

### SUMMARY

In view of the above, embodiments of this disclosure provide a device and a corresponding method that is able to efficiently estimate a categorical CMF type of a user, while having low and/or flexible hardware requirements. Further, embodiments of this disclosure improve a perceived image quality, and reduce the effect of color contrast distortion due to the observer metamerism failure.

These and other objectives are achieved by the solutions of this disclosure as described in the independent claims. Advantageous implementations are further defined in the dependent claims.

A first aspect of this disclosure provides a device for estimating a categorical color matching function, CMF, type of a user, the device being configured to: cause a display to show a set of two or more binary color tests; wherein each binary color test corresponds to a pair of a categorical CMF type A and a categorical CMF type B of a predetermined set of categorical CMF types, and wherein each binary color test comprises: a first picture for the categorical CMF type A of the pair, the first picture including a color contrast that is larger than a first threshold for a user A corresponding to the categorical CMF type A and smaller than a second threshold for a user B corresponding to the categorical CMF type B, and a second picture for the categorical CMF type B of the pair, the second picture including a color contrast that is larger than the first threshold for the user B and smaller than the second threshold for the user A, wherein the second threshold is a discrimination threshold, and wherein the first threshold is equal to or larger than the second threshold; the device being further configured to: calculate a score for each categorical CMF type in the predetermined set of categorical CMF types based on input information received in response to causing the display to show the set of binary color tests; and select, for the user, a categorical CMF type corresponding to a largest or smallest score.

The device of the first aspect can efficiently estimate the categorical CMF type of a user by displaying binary color tests and analyzing corresponding user input information. Thereby, advantageously, the hardware requirements and/or display requirements of the device of the first aspect are low. For example, the categorical observer types of a user may be determined with only one display. For example, the device may be a smartphone and/or may comprise only three display primaries. No special and/or additional equipment may be required by the device, and the display may be a screen of a smartphone or a gadget. The requirement on the number of different display primaries of the display may be lower than for conventional solutions. The device may also be able to reduce the effect of color contrast distortion due to the observer metamerism failure, by configuring a color imaging pipeline according to a selected CMF type.

Further, more categorical CMF types may be distinguishable compared to the conventional solutions, and/or the number of considered categorical CMF types may be more flexibly adjusted.

Further, the device is not limited to one set of binary color tests and may flexibly estimate a CMF type of a user with a different set of binary color tests.

The first threshold may be larger than the second threshold. Alternately, the first and second threshold may be equal. For example, the first and second threshold may be the same discrimination threshold.

The first and/or second threshold may be measured, for example, based on CIEDE2000 in deltaE, or dE units.

The discrimination threshold may be a threshold of color contrast that separates the color contrasts that are perceptible and not perceptible by a user. For example, a discrimination threshold may be equal to 2 dE according to the CIEDE2000 metric, and the color contrast according the CIEDE2000 metric for a user of a categorical CMF type A may be less than 2 dE and not distinguishable.

The discrimination threshold may be equal to a minimum color contrast of two colors that a user can discriminate and/or distinguish.

The discrimination threshold may be equal to a minimum color contrast that a user can perceive.

The first and second threshold may be based on experimental results, for example, testing and comparing various first and second threshold values.

In a further implementation form of the first aspect, the input information comprises for each binary color test one of: the first picture was selected; the second picture was selected; neither picture was selected.

In a further implementation form of the first aspect, each score is calculated based on a weighted sum, and each summand in each weighted sum corresponds to one binary color test and is equal to a weight, if a picture was selected that corresponds to the categorical CMF type of the weighted sum, or is equal to zero otherwise.

In a further implementation form of the first aspect, the predetermined set of categorical CMF types is based on two or more display primaries of the display, and/or wherein of the predetermined set of categorical CMF types, each different categorical CMF type is paired once with each other categorical CMF type to form the categorical CMF type pairs.

Alternatively, the predetermined set of categorical CMF types may be based on three or more display primaries of the display. For example, the predetermined set of categorical CMF types may be based on three display primaries of the display, as smartphone displays typically comprise exactly three display primaries.

In a further implementation form of the first aspect, for each picture the color contrast is: maximized or almost maximized for users of the corresponding categorical CMF type, and minimized or almost minimized for users of the other categorical CMF type of the pair.

In a further implementation form of the first aspect, each picture comprises a color pair of two colors, and the set of binary color tests comprises respectively, for each categorical CMF type pair, M different binary color tests and 2*M different color pairs, wherein M is a positive integer larger than one.

In a further implementation form of the first aspect, the device is configured to cause the display to show each binary color test in the set two or more times.

The set of binary color test may comprise each different binary color test two or more times.

In a further implementation form of the first aspect, each score is calculated based on a weighted sum, and wherein the device is configured to determine weights of each weighted sum based on one or more of the following weight sub-types: priori weights; individual posteriori weights; general posteriori weights; statistical posteriori weights.

In a further implementation form of the first aspect, the device is further configured to determine one or more of individual posteriori weights, based on a reliability of the selections of the user for each binary color test, when causing the display to show each binary color test two or more times; and/or general posteriori weights, based on an overall reliability of the selections of the user for all binary color tests, when causing the display to show each binary color test two or more times.

A general posteriori weight may be a parameter for estimating the reliability of the user as a respondent. Assuming in the following example that each binary color test is shown twice to the user, and the general posteriori weight is normalized, if the general posteriori weight is closer to one, then the first and second answers of the user on the same test often coincided. Thus, the user may be considered reliable and the user's answers may provide reliable information. If the general posteriori weight is, for example, below 0.5, then this indicates that the user's answers may not be reliable, and the color imaging workflow should be based on the standard observer.

In a further implementation form of the first aspect, the priori weights are determined for each picture, based on comparing a calculated color contrast of the respective picture to a calculated color contrast corresponding to the respective same categorical CMF type pair and categorical CMF type, and minimizing an objective function; and/or the statistical posteriori weights are determined based on statistics of the reliability of the selections of a plurality of users for each binary color test, when the display is caused to show each binary color test two or more times.

In a further implementation form of the first aspect, the weights of each weighted sum are equal to one of: The individual posteriori weights; the individual posteriori weights multiplied with a T-norm of the priori weights and the general posteriori weights; the individual posteriori weights multiplied with the statistical posteriori weights and a T-norm of the priori weights and the general posteriori weights.

In a further implementation form of the first aspect, the device is further configured to cause a display to show a picture according to the selected categorical CMF type, and a picture according to a standard observer CMF type, and obtain input information regarding which CMF type is selected.

Additional binary color tests may displayed on the display for validation of the estimated categorical CMF type of the user. If the validation is not successful, then the CMFs of the standard observer may be selected instead of the estimated categorical CMF type, or the categorical CMF type of the user may be estimated again.

In a further implementation form of the first aspect, the device is further configured to configure a color imaging pipeline according to the selected CMF type.

A second aspect of this disclosure provides a device for creating a set of binary color tests, the device being configured to: determine a set of categorical color matching function, CMF, types based on two or more display primaries of a display; create one or more categorical CMF type pairs, each categorical CMF type pair comprising a categorical CMF type A and a categorical CMF type B, wherein out of the set of categorical CMF types each categorical CMF type is paired once with each other categorical CMF type; determine, for each categorical CMF type pair, a first pair of colors having a color contrast that is larger than a first threshold for a user A corresponding to the categorical CMF type A and smaller than a second threshold for a user B corresponding to the categorical CMF type B, and a second pair of colors having a color contrast that is larger than the first threshold for the user B and smaller than the second threshold for the user A, wherein the second threshold is a discrimination threshold, and wherein the first threshold is equal to or larger than the second threshold; create, for each categorical CMF type pair, two pictures including a first picture corresponding to the categorical CMF type A and comprising a pattern of the first pair of colors, and including a second picture corresponding to the categorical CMF type B and comprising a pattern of the second pair of colors; and create a first set of binary color tests, each binary color test corresponding to a categorical CMF type pair and comprising the corresponding two created pictures.

The set of binary color tests may comprise or consist of the first set of binary color tests.

The set of categorical CMF types may be the predetermined set of CMF types of the first aspect.

Out of the set of categorical CMF types, some categorical CMF types may not be paired with each other categorical CMF type to create the one or more categorical CMF type pairs. For example, the number of binary color tests in the set of binary color tests may be reduced by reducing the number of categorical CMF type pairs. A smaller set of binary color tests may require less input information from a user, but may lead to a less accurate estimation of the categorical CMF type of the user.

In a further implementation form of the second aspect, for each picture the color contrast is: maximized or almost maximized for users of the corresponding categorical CMF type, and minimized or almost minimized for users of the other categorical CMF type of the pair, by minimizing or almost minimizing an objective function depending on the color contrast for users of both categorical CMF types of the pair.

In a further implementation form of the second aspect, almost minimizing the objective function refers to: a color contrast for users of both categorical CMF types of the pair resulting in at least an Nth smallest objective function output, N being a positive integer between two and ten; or a color contrast for users of both categorical CMF types of the pair resulting in an objective function output that is below a predetermined threshold.

Alternatively, N may be a positive integer larger than one.

Further, almost minimizing the objective function may refer to a color contrast for users of both categorical CMF types of the pair resulting in a local minima of an objective function output and/or a color contrast resulting in an N′″th smallest local minima of an objective function output, N′″ being a positive integer larger than one.

A color contrast may be in reference to users of both categorical CMF types of the pair. For example, a color contrast may refer to: a first color contrast for a user of categorical CMF type A and a second color contrast for a user of categorical CMF type B.

In a further implementation form of the second aspect, the device is further configured to create, for each categorical CMF type pair, one or more additional binary color tests, wherein each picture of each additional binary color test comprises at least one different color compared to each picture corresponding to the respective same categorical CMF type pair, and wherein the additional binary color tests and the first set of binary color tests define a second set of binary color tests.

The set of binary color tests may comprise or consist of the second set of binary color tests.

In a further implementation form of the second aspect, the device is further configured to create one or more duplicates of each binary color test in the first set or second set of binary color tests.

The set of binary color tests may comprise or consist of all binary color tests in the first set of binary color tests and the duplicates of each binary color test in the first set of binary color tests. Alternatively, the set of binary color tests may comprise or consist of all binary color tests in the second set of binary color tests and the duplicates of each binary color test in the second set of binary color tests.

In a further implementation form of the second aspect, the device is further configured to: create priori weights for each picture by: calculating a first color contrast of the respective color pair, calculating a second color contrast of a color pair corresponding to the respective same categorical CMF type pair and categorical CMF type, and minimizing the objective function, and comparing the first and second color contrast; and/or create statistical posteriori weights based on statistics of the reliability of the selections of a plurality of users for each binary color test when each binary color test is included in the set two or more times.

A third aspect of this disclosure provides a method of operating a device for estimating a categorical color matching function, CMF, type of a user, the method comprising: causing a display to show a set of two or more binary color tests; wherein each binary color test corresponds to a pair of a categorical CMF type A and a categorical CMF type B of a predetermined set of categorical CMF types, and wherein each binary color test comprises: a first picture for the categorical CMF type A of the pair, the first picture including a color contrast that is larger than a first threshold for a user A corresponding to the categorical CMF type A and smaller than a second threshold for a user B corresponding to the categorical CMF type B, and a second picture for the categorical CMF type B of the pair, the second picture including a color contrast that is larger than the first threshold for the user B and smaller than the second threshold for the user A, wherein the second threshold is a discrimination threshold, and wherein the first threshold is equal to or larger than the second threshold; the method further comprising: calculating a score for each categorical CMF type in the predetermined set of categorical CMF types based on input information received in response to causing the display to show the set of binary color tests; and selecting, for the user, a categorical CMF type corresponding to a largest or smallest score.

The method of the third aspect may have implementation forms that correspond to the implementation forms of the device of the first aspect. The method of the third aspect and its implementation forms achieve the advantages and effects described above for the device of the first aspect and its respective implementation forms.

A fourth aspect of this disclosure provides a method of operating a device for creating a set of binary color tests, the method comprising: determining a set of categorical color matching function, CMF, types based on two or more display primaries of a display; creating one or more categorical CMF type pairs, each categorical CMF type pair comprising a categorical CMF type A and a categorical CMF type B, wherein out of the set of categorical CMF types each categorical CMF type is paired once with each other categorical CMF type; determining, for each categorical CMF type pair, a first pair of colors having a color contrast that is larger than a first threshold for a user A corresponding to the categorical CMF type A and smaller than a second threshold for a user B corresponding to the categorical CMF type B, and a second pair of colors having a color contrast that is larger than the first threshold for the user B and smaller than the second threshold for the user A, wherein the second threshold is a discrimination threshold, and wherein the first threshold is equal to or larger than the second threshold; creating, for each categorical CMF type pair, two pictures including a first picture corresponding to the categorical CMF type A and comprising a pattern of the first pair of colors, and including a second picture corresponding to the categorical CMF type B and comprising a pattern of the second pair of colors; and creating a first set of binary color tests, each binary color test corresponding to a categorical CMF type pair and comprising the corresponding two created pictures.

The method of the fourth aspect may have implementation forms that correspond to the implementation forms of the device of the second aspect. The method of the fourth aspect and its implementation forms achieve the advantages and effects described above for the device of the second aspect and its respective implementation forms.

A fifth aspect of this disclosure provides a computer program product comprising a program code for controlling a device according to the first aspect or the second aspect or any of its implementation forms, or for performing, when the program code is executed on a computer, a method according to the third aspect or the fourth aspect or any implementation form thereof.

Each observer may have a set of CMFs, which determines the personalized color perception. A plurality of sets of CMFs of different observers may be divided into groups, i.e., categorical CMF types, wherein each group may be described with a set of CMFs. Each categorical observer type may represent a group or cluster of individual observers with similar sets of CMFs. Each observer may correspond to only one type of categorical observer, which is determined by each observers individual set of CMFs. A categorical CMF type of a user may be determined by the closeness of the users individual set of CMFs to a set of generalized categorical set of CMFs. For each type of observer a specific signal processing pipeline may be employed.

In this disclosure, the phrases “categorical observer type” and “categorical CMF type” may be used interchangeably.

Further, in this disclosure the words “user” and “observer” may be used interchangeably.

Further, in this disclosure the words “picture” and “image” may be used interchangeably.

Two binary color tests may be considered duplicates, identical and/or not different, if they comprise the exact same pictures. Alternatively, two binary color tests may be considered duplicates, identical and/or not different, if they comprise pictures that comprise the exact same color pairs but different patterns. Alternatively, two binary color tests may be considered duplicates, identical and/or not different, if they comprise pictures that comprise only slightly different color pairs.

In this disclosure, the word “reliable” may refer to something being consistent and/or something being in-line with a fundamental truth or a final result. For example, a sub-weight may be reliable, if its value aligns with a categorical CMF type of a user and/or a finally estimated categorical CMF type of a user.

It has to be noted that all devices, elements, units and means described in the disclosure could be implemented in the software or hardware elements or any kind of combination thereof. All steps which are performed by the various entities described in the disclosure as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of embodiments in relation to the enclosed drawings, in which

FIG. 1 shows a device for estimating a categorical CMF type of a user according to an embodiment of this disclosure.

FIG. 2 shows a device for creating a set of binary color tests according to an embodiment of this disclosure.

FIG. 3 shows two sets of CMFs according to two prevalent definitions of the standard observer.

FIG. 4 shows a procedure for determining color pairs for observer classification according to an embodiment of this disclosure.

FIG. 5 shows a summary of calculation steps that maximize a color contrast for categorical observers of type A and minimize a color contrast for categorical observers of type B according to an embodiment of this disclosure.

FIG. 6 shows steps included in the estimation of a categorical observer type of a user according to an embodiment of this disclosure.

FIG. 7 shows a method for personalized color imaging and/or adjusting the color imaging workflow of a device according to an embodiment of this disclosure.

FIG. 8 shows a method according to an embodiment of this disclosure.

FIG. 9 shows a method according to an embodiment of this disclosure.

### DETAILED DESCRIPTION OF EMBODIMENTS

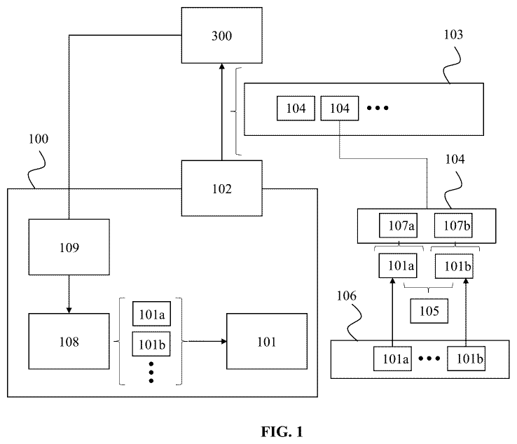

FIG. 1 shows a device 100 for estimating a categorical CMF type 101 of a user 300. The device 100 is configured to cause a display 102 to show a set 103 of two or more binary color tests 104. The device 100 may comprise the display 102 or may be connected to the display 102. The device 100 may be a smartphone comprising the display 102.

Each binary color test 104 comprises a first picture 107a for a categorical CMF type A 101a, and a second picture 107b for a categorical CMF type B 101b. The categorical CMF type A 101a and the categorical CMF type B 101b are comprised in a pair 105 of categorical CMF types that corresponds to the binary color test 104. Further, the categorical CMF type A 101a and the categorical CMF type B 101b are comprised in a predetermined set 106 of categorical CMF types.

FIG. 1 further shows that the device 100 may receive input information 109 from the user 300, as a response to causing the display 102 to show the set 103 of binary color tests 104. The device 100 is configured to calculate a score 108 for each categorical CMF type 101 in the predetermined set 106 of categorical CMF types based on the received input information 109. Further, the device is configured to select, for the user 300, a categorical CMF type 101 corresponding to a largest or smallest score 108.

The first picture 107a includes a color contrast that is larger than a first threshold for a user A corresponding to the categorical CMF type A 101a, and that is smaller than a second threshold for a user B corresponding to the categorical CMF type B 101b. The second picture 107b includes a color contrast that is larger than the first threshold for the user B and smaller than the second threshold for the user A, wherein the second threshold is a discrimination threshold, and wherein the first threshold is equal to or larger than the second threshold.

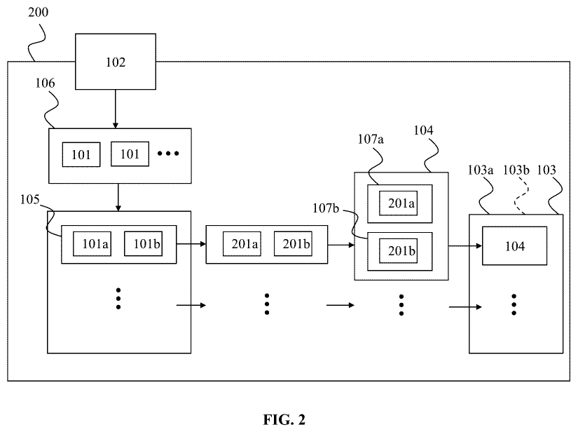

FIG. 2 shows a device 200 for creating a set 103 of binary color tests 104. The device 200 may be a computing device. The device 200 may possibly be integral with the device 100, but usually these devices 100 and 200 are separate devices.

The device 200 is configured to determine a set 106 of categorical CMF types 101 based on two or more display primaries of a display 102 and create one or more categorical CMF type pairs 105. Each categorical CMF type pair 105 comprises a categorical CMF type A 101a and a categorical CMF type B 101b, wherein out of the set 106 of categorical CMF types each categorical CMF type 101 is paired once with each other categorical CMF type 101.

Further, the device 200 is configured to determine for each categorical CMF type pair 105, a first pair of colors 201a having a color contrast that is larger than a first threshold for a user A corresponding to the categorical CMF type A 101a and smaller than a second threshold for a user B corresponding to the categorical CMF type B 101b, and a second pair of colors 201b having a color contrast that is larger than the first threshold for the user B and smaller than the second threshold for the user A. The second threshold is a discrimination threshold. The first threshold is equal to or larger than the second threshold.

Further, the device 200 is configured to create, for each categorical CMF type pair 105, two pictures including a first picture 107a corresponding to the categorical CMF type A 101a and comprising a pattern of the first pair of colors 201a, and including a second picture 107b corresponding to the categorical CMF type B 101b and comprising a pattern of the second pair of colors 201b. The first picture 107a and the second picture 107b are comprised in a binary color test 104.

Further, the device 200 is configured to create a first set 103a of binary color tests comprising for each categorical CMF type pair 105 a binary color test that corresponds to the categorical CMF type pair 105 and comprises the corresponding two created pictures 107a, 107b.

The set 103 of binary color tests may comprise or consist of the first set 103a of binary color tests. The set 103 of binary color tests may comprise or consist of the second set 103b of binary color tests. The second set 103b of binary color tests may comprise the first set 103a of binary color tests.

The device 200 may be configured to provide the created first set of binary color tests 103a to the devices 100. Further, the device 200 may be configured to provide the created second set of binary color tests 103b and/or the created set of binary color tests 103 to the devices 100.

A set of CMFs of a particular user 300 of the device 100 may differ from a set of CMFs of a standard observer. Thus, optimizing an image processing pipeline of the device 100 for a standard observer may lead to a decreased perceived color contrast for the user 300. By adjusting the color imaging workflow based on a categorical CMF type 101 instead of the set of CMFs of a standard observer, a color contrast may be improved and personalized for each particular user 300 by the device 100. The categorical CMF type 101 may be estimated by the device 100 and the corresponding image processing pipeline may be provided.

The categorical CMF types 101 may be estimated by the device 100 for each user 300 based on a set of binary color tests 103 generated by the device 200. Each binary color test 104 may be presented to a user 300 on the display 102 by the device 100, for example, on a display of a smartphone. Further, a classification rule for processing user responses may be used by the device 100 to automatically estimate the categorical CMF type 101 of the user 300. Some advantages provided by this disclosure, particularly, by the devices 100 and 200 are elaborated in the following.

In modern colorimetric theory, a test color stimulus can be matched using an additive mixture of three independent primary stimuli, wherein none of the independent primary stimuli can be matched by an additive mixture of the other two. A set of three CIE standard CMFs may be used to calculate three-color stimulus values XYZ according to the following equations:

$$X = \frac{1}{{N}^{″}} {\int }_{λ} \overline{x} ( λ ) P ( λ ) d λ$$

$$Y = \frac{1}{{N}^{″}} {\int }_{λ} \overline{y} ( λ ) P ( λ ) d λ$$

$$Z = \frac{1}{{N}^{″}} {\int }_{λ} \overline{z} ( λ ) P ( λ ) d λ$$

$${N}^{″} = {\int }_{λ} \overline{y} ( λ ) I ( λ ) d λ$$

wherein P(λ) is a spectral power distribution of an emissive source, x̅(λ), y̅(λ), z̅(λ) are CIE standard color matching functions (CMFs), N″ is a normalization factor, and I(λ) is a reference white illuminant.

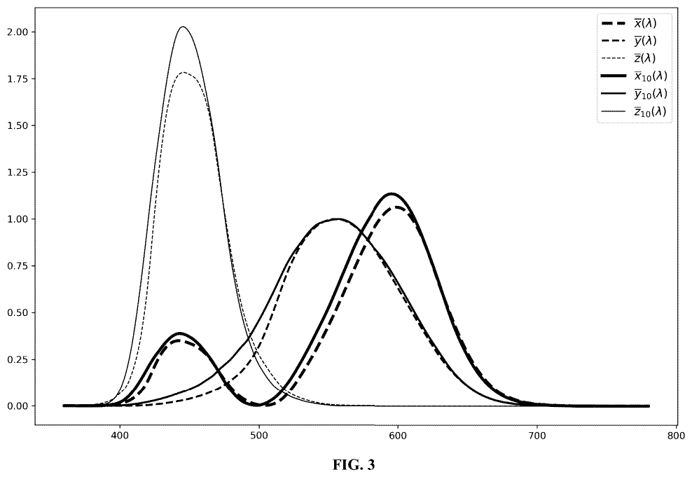

The current typical color imaging workflow of a conventional device is based on a single standard observer and assumes all observers possess an identical set of CMFs. FIG. 3 shows two sets of CMFs according to two prevalent definitions of the standard observer: the CIE Standard Colorimetric Observer with two-degree visual field (x̅(λ), y̅(λ), z̅(λ)) and the CIE Standard Colorimetric Observer with ten-degree visual field (x̅₁₀(λ), y̅₁₀(λ), z̅₁₀(λ)).

The classification of categorical CMF types 101 may be based on the metamerism effect. Different types 101 of categorical observers perceive colors differently according to the metamerism phenomena.

Categorical observer classification may be based on finding a pair of colors, which gives a large visual difference for only one categorical type of observer 101 and a low visual difference for other types of categorical observers 101.

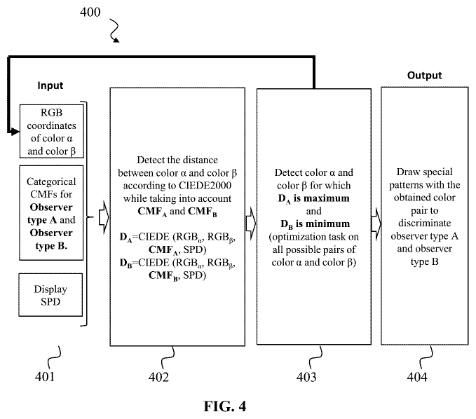

FIG. 4 shows a procedure 400 for determining color pairs 201a, 201b for observer classification based on the metamerism effect, wherein a plurality of color pairs comprising a color α and a color β are tested to determine color pairs 201a, 201b that optimize observer classification within a categorical observer type pair 105 comprising a categorical observers type A 101a and a categorical observers type B 101b. The procedure 400 may be performed by the device 200. The input values received in a first step 401 for each loop of the procedure are RGB coordinates of a color α and a color β, two sets of CMFs (CMF_{A} and CMF_{B}) for two categorical CMF types 101 (type A and type B), and the display primaries (SPDs) of a display 102.

The metric CIEDE2000 may be used for visual difference estimation. Coordinates of colors may be defined in sRGB space. For example, for a color α, the coordinates may be (R_{α}, G_{α}, B_{α}) and for a color β, the coordinates may be (R_{β}, G_{β}, B_{β}). The spectrum of these colors when displayed with a display 102 may be determined as follows based on the SPD functions, i.e. primaries, SPD_{R}(λ), SPD_{G}(λ), SPD_{B}(λ) of the display 102:

$${Sp\_color}_{α} ( λ ) = {R}_{α} \cdot {SPD}_{R} ( λ ) + {G}_{α} \cdot {SPD}_{G} ( λ ) + {B}_{α} \cdot {SPD}_{B} ( λ )$$

$${Sp\_color}_{β} ( λ ) = {R}_{β} \cdot {SPD}_{R} ( λ ) + {G}_{β} \cdot {SPD}_{G} ( λ ) + {B}_{β} \cdot {SPD}_{B} ( λ )$$

Calculating a perceived color difference according to the CIEDE2000 formula may be based on tristimulus values in CIE 1931 XYZ color space from the spectral representation of color. The tristimulus values can be obtained for any spectral color given the CMF of the observer. XYZ coordinates of these colors may be obtained based on a set of color matching functions of a categorical observer type k 101. On the base of these coordinates, a CIEDE2000 color difference between these two colors may be calculated.

The set 106 of categorical CMF types may comprise ten categorical CMF types 101. However, more or less categorical CMF types 101 may be used. On the one hand, the number of binary color tests depends on the number of categorical CMF types 101. Thus, it may be preferred to decrease the number of categorical CMF types 101. On the other hand, increasing the number of categorical CMF types 101 enables more precise categorization.

CIEDE2000 metrics may be calculated based on two colors α and β showing a visual color contrast for a categorical observer type k 101:

$${x\_color}_{α} = {\int }_{λ min}^{λ max} {Sp\_color}_{α} ( λ ) \cdot {x\_cat}_{k} ( λ ) d λ \\ \\ \\ {y\_color}_{α} = {\int }_{λ min}^{λ max} {Sp\_color}_{α} ( λ ) \cdot {y\_cat}_{k} ( λ ) d λ \\ \\ \\ {z\_color}_{α} = {\int }_{λ min}^{λ max} {Sp\_color}_{α} ( λ ) \cdot {z\_cat}_{k} ( λ ) d λ \\ \\ \\ {x\_color}_{β} = {\int }_{λ min}^{λ max} {Sp\_color}_{β} ( λ ) \cdot {x\_cat}_{k} ( λ ) d λ \\ \\ \\ {y\_color}_{β} = {\int }_{λ min}^{λ max} {Sp\_color}_{β} ( λ ) \cdot {y\_cat}_{k} ( λ ) d λ \\ \\ \\ {z\_color}_{β} = {\int }_{λ min}^{λ max} {Sp\_color}_{β} ( λ ) \cdot {z\_cat}_{k} ( λ ) d λ \\ \\ \\ Δ {E}_{α β}^{cat\_k} = func\_CIEDE 2000 ( {x\_color}_{α} , {y\_color}_{α} , {z\_color}_{α} , {x\_color}_{β} , {y\_color}_{β} , {z\_color}_{β} )$$

where x_catₖ(λ), y_catₖ(λ), z_catₖ(λ) are the CMFs of a categorical observer of type k 101.

FIG. 4 shows a second step 402 including calculating a distance D_{A}=ΔE_{αβ}^{cat_A} and D_{B}=ΔE_{αβ}^{cat_B} between color α and color β according to CIEDE2000 for categorical observer type A 101a and categorical observer type B 101b.

The first step 401 and the second step 402 may be repeated one or more times to calculate the color distance between a plurality of color pairs each comprising a color α and a color β.

The third step 403 of FIG. 4 includes determining two colors α and color β for which D_{A} is maximal and D_{B} is minimal. This represents an optimization task on all possible pairs of a color α and a color β.

To find two colors α and 3 which lead to a maximum value of ΔE_{αβ}^{cat_A} for a categorical observer of type A 101a a function for solving such a minimization task may be defined as follows:

$${min}_{{R}_{α} , {G}_{α} , {B}_{α} , {R}_{β} , {G}_{β} , {B}_{β}} [ \frac{1}{Δ {E}_{α β}^{cat\_A}} ]$$

Further, the pair 201a, 201b of the colors α and β with initial coordinates (R_{α}, G_{α}, B_{α}) for color α and (R_{β}, G_{β}, B_{β}) for color β should minimize or almost minimize CIEDE2000 metrics for XYZ coordinates obtained with CMFs of another categorical observer type 101, e.g., categorical observer type B 101b.

$${min}_{{R}_{α} , {G}_{α} , {B}_{α} , {R}_{β} , {G}_{β} , {B}_{β}} [ \frac{1}{Δ {E}_{α β}^{c a {t}_{-} A}} ] and Δ {E}_{α β}^{cat\_B} < Δ {E}_{t h r}$$

where ΔEₜₕᵣ is a threshold.

According to these conditions an objective function may be created, wherein the objective function may maximize visual color contrast for one categorical observer type 101, e.g. type A 101a, and may minimize visual color contrast for another categorical observer type 101, e.g. type B 101b.

An optimization task may include finding colors α and β that minimize or almost minimize the objective function. For example, the objective function may be defined by the following equation for observer pairs 105 of categorical observer type A 101a (cat_A) and categorical observer type B 101b (cat_B), wherein cat_A is a target categorical observer:

$$Obj\_func = \frac{1}{{E}_{α β}^{cat\_A}} + F ( Δ {E}_{α β}^{cat\_B} )$$

$$F ( x ) = {( x - t h {r}_{max} )}^{2}$$

The threshold value thrₘₐₓ may be determined based on experiments. Based on experiments of solving the optimization problem of above for the three threshold values thrₘₐₓ: 1, 2, and 5 for the Huawei Mate 20 Pro SPD it was shown that the color contrast between two colors for the target (observer A) and non-target observer (observer B) may not be significantly changed. Thus, very large threshold values may not be preferred. Based on a further analysis of the obtained test images a viable threshold value of thrₘₐₓ=2 was determined. Other threshold values may also be used.

Determining color pairs 201a, 201b may be implemented by minimizing or almost minimizing the following objective function:

$${min}_{{R}_{α} , {G}_{α} , {B}_{α} , {R}_{β} , {G}_{β} , {B}_{β}} [ \frac{1}{Δ {E}_{α β}^{c a {t}_{-} A}} + {( Δ {E}_{α β}^{cat\_B} - 2 )}^{2} ]$$

By minimizing or almost minimizing the objective function, two colors 201a may be determined that have a large color contrast for observers of categorical CMF type A 101a and a small color contrast, i.e. similar colors, for observers of categorical CMF type B 101b.

Almost minimizing an objective function may refer to determining arguments of said objective function, e.g., a color pair and a categorical CMF type pair 105, or a color contrast for a user 300 of categorical CMF type A 101a and a color contrast for a user 300 of a categorical CMF type B 101b, that result in one or more of the following: at least an Nth smallest objective function output; an objective function output that is below a predetermined threshold; a local minima of an objective function output; and an N′″th smallest local minima of an objective function output.

N may be a positive integer larger than one, N′″ may be a positive integer larger than one, and the predetermined threshold may be determined iteratively and/or experimentally by testing and/or comparing a plurality of thresholds.

The arguments, e.g., color pairs and categorical CMF type pairs 105, or color contrasts, that minimize or almost minimize an objective function may be determined iteratively and/or experimentally by testing and/or comparing a plurality of arguments. For example, a plurality of objective function outputs for a plurality of color contrasts may be calculated, and compared to each other and/or compared to one or more of the above requirements.

The fourth step 404 of FIG. 4 includes drawing a special pattern, i.e. a picture, with the obtained color pair 201a of the third step 403, which may be able to discriminate observer type A 101a from observer type B 101b. The procedure 400 may be repeated to create a pattern with another color pair 201b that maximizes the distance D_{B} and minimizes the distance D_{A}. Thus, for each CMF type pair 105 two pictures 107a, 107b may be created. Further, creating two pictures 107a, 107b as above may be repeated accordingly for other categorical observer type pairs 105, wherein each two pictures 107a, 107b may form a binary color test 104.

The minimization task may be solved for all possible pairs 105 of categorical observer types. The number of categorical observer type pairs N″ may be determined by the following combinatorial equation:

$${N}^{″} = {C}_{K}^{2} = \frac{K !}{2 ( K - 2 ) !}$$

where K is the number of categorical observer types 101. Thus, the total number of different test pictures for a set 103, 103a of binary color tests may be, for example, 2N″, with one binary color test 104 for each categorical CMF type pair 105 and two pictures 107a, 107b for each binary color test 104.

The set 103 of binary color tests may include multiple different binary color tests 104 for each categorical observer type pair 105. Further, the set 103 of binary color tests may additionally include duplicates, and/or slightly altered duplicates of each different binary color test 104.

Binary color tests 104 may be created based on the determined color pairs 201a, 201b. Each binary color test 104 may include two pictures 107a, 107b in the form of a circle, wherein each circle may comprise a symbol or pattern on a background. On a first circle 107a the color difference between a symbol and a background may be clear for observers of categorical type A 101a and not clear for observers of categorical type B 101b. On the second picture 107b the color difference between symbol and background may be clear for observer of categorical type B 101b and not clear for observer of categorical type A 101b. Various different shapes and patterns may be used.

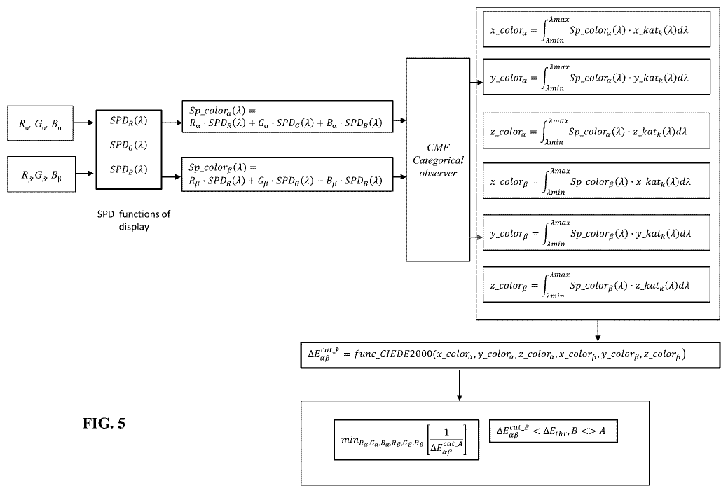

FIG. 5 shows a summary of the calculation steps described above to find color pairs 201a that maximize a color contrast for categorical observers of type A 101a and minimize a color contrast for categorical observers of type B 101b. The calculation steps may be performed by the device 200.

The observer classification may be based on user input information 109 associated with a set 103 of binary color tests. The observer classification may be performed by the device 100. A classification rule may be based on so-called pairwise classification. According to the results of the classification of all pairs of pictures 107a, 107b, i.e. binary color tests 104, a decision may be made whether a user 300 belongs to one of the classes, i.e. categorical CMF types 101.

Experimental results show that it may be preferred to implement a classification rule for determining the categorical observer type 101 on the base of “quantity of voting” for each categorical observer type 101. “Quantity of voting” refers to how many times during the testing process the user 300 selected an image corresponding to a specific categorical observer type 101 as having a more significant color contrast

Each binary color test 104 may be shown to the user 300 multiple times.

Alternatively, for each binary color test 104 multiple binary color tests 104 comprising the same color pairs 201a, 201b but different patterns may be created.

For each binary color test 104 the user 300 may chose the first picture 107a, the second picture 107b, or neither picture, e.g. to skip a binary color test 104. According to one or more selections of the user 300 a matching parameter μᵢ^{k} may be introduced. In a preferred example, each different binary color test 104 may be shown to the user 300 two times. Thus, the user input information 109 for each different binary color test 104 may consists of the two answers: answer₁ and answer₂, i.e. one answer for each identical binary color test 104.

The matching parameter μᵢ^{k} may be defined as follows:

$${μ}_{i}^{k} = \{ \begin{matrix}0.5 , if {answer}_{1} = {answer}_{2} ⋂ {answer}_{1} \neq skip \\ 0.25 , if {answer}_{1} \neq {answer}_{2} ⋂ ( {answer}_{1} = skip ⋃ {answer}_{2} = skip ) \\ 0 , else\end{matrix}$$

Assuming a user 300 was presented with a same binary color test 104 twice and selected each time a same picture 107a corresponding to categorical observer type A 101a instead of a picture 107b corresponding to categorical observer type B 101b, then the matching parameter μᵢ^{A} for each of the two binary color tests 104 may be 0.5. Both binary color tests 104 may be considered for calculating a score 108 and estimating a categorical CMF type 101 of the user 300. Thus, the matching parameter of both binary color tests 104 may add up to 1 representing ideal reliability of the user 300 regarding the binary color test i 104.

Further, the score 108 corresponding to categorical observer type A 101a would increase and the score 108 corresponding to categorical observer type B 101b would stay the same. Assuming the user 300 selected the pictures 107b corresponding to categorical observer type B 101b, then the score 108 corresponding to categorical observer type B 101b would increase and the score 108 corresponding to categorical observer type A 101a would stay the same.

In general, the matching parameter μᵢ^{A} of each binary color test 104 identical to binary color test 104 i may be defined as follows:

$${μ}_{i}^{A} = \{ \begin{matrix}\frac{{N}_{1} - {N}_{2}}{{N}_{3}^{2}} , if {N}_{2} - {N}_{1} > 0 \\ 0 , else\end{matrix}$$

where N₁ is the number of times the user 300 selected the picture 107a corresponding to the categorical observer type A 101a when presented with binary color test i 104 or one of the binary color tests 104 identical to binary color test i 104, N₂ is the number of times the user 300 selected the picture 107b corresponding to the categorical observer type B 101b when presented with binary color test i 104 or one of the binary color tests 104 identical to binary color test i 104, and N₃ is the number of times the binary color test i 104 or the binary color tests 104 identical to binary color test i 104 were displayed on the display 102 and/or shown to the user 300.

The matching parameter may be normalized based on the number of duplicates of each different binary color tests 104 in the set 103 of binary color tests.

The matching parameter may be normalized differently than in the examples above.

The matching parameter may be identical for each identical binary color test 104.

For example, the matching parameter may be defined in another way, wherein reliable selections increase a score 108 compared to unreliable selections.

For example, the matching parameter may be defined in another way, wherein reliable selections decrease a score 108 compared to unreliable selections.

The matching parameter μᵢ^{A} may also be referred to as individual posteriori weights (weightᵢ^{p_i_A}).

A score 108 for a categorical observer type A 101a (Cat_type[A]) may be calculated according to “quantity of voting” as follows:

$$Cat\_type [ A ] = Cat\_type [ A ] + R\_weight \_i \cdot {μ}_{i}^{A}$$

wherein R_weight_i may be based on one or more additional sub-weights corresponding to binary color test i 104 and binary color tests 104 identical to binary color test i 104.

Alternatively, the score 108 for Cat_type[A] may be defined as follows:

$$Cat\_type [ A ] = Cat\_type [ A ] + {weight}_{i}^{A}$$

wherein all sub-weight types are combined into an overall weight (weightᵢ^{A}) corresponding to binary color test i 104 and binary color tests 104 identical to binary color test i 104.

The overall weights may depend on an answer of the user 300 for each binary color test 104. For each binary color test 104 there may be two overall weights: weightᵢ^{A} and weightᵢ^{B}. At least one of the overall weights for each binary color test 104 may represent minimal reliability, e.g. may be equal to 0. Thus, one of the overall weights for each binary color test 104 may be neglected and/or not added to a score 108 to increase said score 108.

The sub-weights may depend on an answer of the user 300 for each binary color test 104. For each binary color test 104 there may be two sub-weights for each sub-weight type, e.g.: weightᵢ^{p_s,A} and weightᵢ^{p_s,B}, and/or weightᵢ^{pr,A} and weightᵢ^{pr,B}.

The weights for each binary color test 104 may be based on priori and posteriori sub-weights.

Priori weights may be based on an estimation based on CIEDE2000 metrics.

Additional binary color tests 104 may be used and/or created and, for example, added to the first set 103a of binary color tests. Said additional binary color tests 104 may comprise pictures based on additional color pairs that correspond to local minima's of the objective function, and/or almost minimize the objective function.

For each picture, a pair of colors and their CIEDE2000 metric ΔEₘₐₓ₁^{k} corresponding to the corresponding categorical CMF type 101 of the picture, and corresponding to a global minimum of the objective function according to the corresponding categorical CMF type 101 and categorical CMF type pair 105 of the picture may be used to determine priori weights.

Further, the additional pairs of colors and their CIEDE2000 metrics may be used to determine priori weights. The additional pairs of colors may correspond to local minima's of the objective function and/or may almost minimize the objective function according to the corresponding categorical CMF type 101 and categorical CMF type pair 105 of the picture. In an example, additional pairs of colors corresponding to a second and third local minimum of the objective function may be used corresponding to the CIEDE2000 metrics ΔEₘₐₓ₂^{k}, ΔEₘₐₓ₃^{k}. Thus, the total number of different binary color tests 104 in the set 103, 103a of binary color tests may be increased for statistical approving. The additional binary color tests and the first set 103a of binary color tests may form a second set 103b of binary color tests.

The second and third pairs of colors may have a lower degree of reliability and/or may be less useful for estimations of a categorical CMF type 101 of a user 300 than a pair corresponding to a global minimum of the objective function. This may be taken into account by introducing corresponding priori weights. Priori weights may be calculated as follows:

$${weight}_{i , {k}^{′}}^{pr , k} = \frac{Δ {E}_{max {k}^{′} , i}^{k}}{Δ {E}_{max 1 , i}^{k}} , {k}^{′} = 1 , 2 , 3$$

Posteriori weights may include one or more of the following sub-weights: individual posteriori weights, general posteriori weights, statistical posteriori weights.

General posteriori weights may be based on the reliability of the user input information 109. Information about the reliability of the set 103 of binary color tests for a specific user 300 may be obtained based on experimental results of the specific user 300 taking the set 103 of binary color tests. In a preferred example, each binary color test 104 may be displayed two times. According to the answers of the user 300 a matching parameter μᵢ^{k,n} may be used.

$${μ}_{i}^{k , n} = \{ \begin{matrix}1 , if {answer}_{1} = {answer}_{2} ⋂ {answer}_{1} \neq skip \\ 0.5 , if {answer}_{1} \neq {answer}_{2} ⋂ ( {answer}_{1} = skip ⋃ {answer}_{2} = skip ) \\ 0 , else\end{matrix}$$

A general posterior weight may be determined as follows:

$${weight}_{i}^{{p}_{g}} = {\sum }_{n = 1}^{{N}^{′}} \frac{max ( {μ}_{i}^{A , n} , {μ}_{i}^{B , n} )}{{N}^{′}}$$

where N′ is the total number of different binary color tests 104 in the set 103 of binary color tests. General posteriori weights may be an average of the individual posteriori weights. Thus, general posteriori weights may represent a general reliability of a specific user 300 and the corresponding user input information 109, which is based on all binary color tests 104 in the set 103 of binary color tests. For example, a user 300 selecting the picture in each binary color test 104 randomly would most likely be attributed a low overall reliability according to the general posteriori weight. In this case, the user input information 109 may not provide accurate information about the categorical CMF type 101 of the user 300 and may be dismissed. The general posteriori weights may be the same for all binary color test 104 in the set of binary color tests 103 for a specific user 300.

Statistical posteriori weights may be based on the reliability of the user input information 109 of multiple users 300 for each binary color test 104. Experiments may show that some binary color tests 104 are statistically less reliable than other binary color tests 104. Less reliable binary color tests 104 may be substituted with more reliable binary color tests 104. Further, less reliable binary color tests 104 may have smaller statistical posteriori weights. Thus, the impact of less reliable binary color tests 104 on the categorical CMF type 101 estimation may be reduced.

Statistical posteriori weights may be determined as follows:

$${weight}_{i}^{{p}_{s}} = {\sum }_{m = 1}^{{M}^{′}} {\sum }_{n = 1}^{{N}^{′}} \frac{max ( {μ}_{i , m}^{A , n} , {μ}_{i , m}^{B , n} )}{{N}^{′} \cdot {M}^{′}}$$

where N′ is the total number of different binary color tests 104 in the set 103 of binary color tests and M′ is the total number of users 300 that are considered for statistical evaluation of the set 103 of binary color tests.

One or more sub-weights may be combined to a corresponding overall weight. For example, each sub-weight may be multiplied to determine each overall weight. Alternatively, one or more sub-weight types may not be used.

The sub-weights may be combined with one or more of the other weight sub-types based on the T-norm from fuzzy logic theory:

R_weight_i=min(weightᵢ^{p_g},weightᵢ^{pr})

The sub-weights may be combined with one or more of the other weight sub-types based on other functions, for example:

R_weight_i=max(weightᵢ^{p_g},weightᵢ^{p_S})

The overall weights may be defined, for example, as follows:

$${weight}_{i}^{A} = {weight}_{i}^{p\_i , A} \cdot {weight}_{i}^{p\_s} \cdot min ( {weight}_{i}^{p\_g} , {weight}_{i}^{pr , A} )$$

Individual posteriori weights and general posteriori weights may be determined by the device 100, for example, in a smartphone. Priori weights and statistical posteriori weights may be determined by the device 200, for example, in an external processing device that can access more processing power and/or more data than the device 100. The weights calculated in the device 200 may be provided to the device 100. Alternatively, all weights may be determined in the device 100.

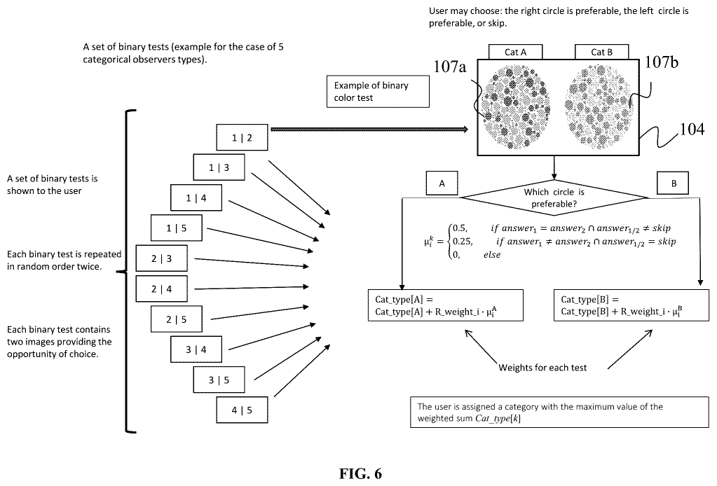

FIG. 6 shows steps that may be included in the estimation of a categorical observer type 101 of a user 300. Said steps may be performed by the device 100. In this example, a set 103 of binary color test is based on 5 categorical observer types 101. Each categorical observer type 101 is paired once with each other categorical observer type 101 defining 10 categorical observer type pairs 105. The set 103 of binary color tests is shown to the user 300, wherein each different binary color test 104 is shown twice in random order. Thus, in total 20 binary color tests 104 are shown to the user 300. Each binary color test 104 contains two pictures 107a, 107b, thus providing opportunity of choice for each binary color test 104.

Further, FIG. 6 shows an exemplary binary color test i 104 comprising two circles each comprising a pattern. Notably, the binary color test 104 is color sensitive and the exemplary pictures in FIG. 6 are only for illustrative purpose. The device 100 may cause the display 102 to show the binary color test 104. The user 300 may choose if the right circle is preferable, the left circle is preferable, or if the binary color test 104 should be skipped. A picture may be preferable if the user 300 perceives a larger color contrast and/or perceives a pattern in one picture more clearly than in the other picture. For example, a pattern may be a number or a letter. A binary color test 104 may be skipped, if the user 300 can't decide which picture is preferable. In the exemplary binary color test 104 shown in FIG. 6, the left picture 107a corresponds to a categorical observer type A 101a and the right picture 107b corresponds to categorical observer type B 101b.

Based on the answer of the user 300, the device 100 receives the user input information 109 (response). Based on said user input information 109, weights may be calculated for the binary color test 104. Matching parameters may be calculated based on two separate answers received from the user 300 regarding the exemplary binary color test 104. For example, if the user 300 prefers the left picture 107a two out of two times, then the matching parameter μᵢ^{A} may be large and/or equal to 0.5 and the matching parameter μᵢ^{B} may be equal to small and/or equal to 0. Further, additional sub-weights may be calculated. The score 108 for the categorical observer type A 101a may be increased by adding the matching parameter multiplied with the additional sub-weights to the score 108. On the other hand the score 108 for the categorical observer type B 101b may not be increased as the matching parameter μᵢ^{B} may be equal to 0. Adjusting the score 108 as above may be repeated for each binary color test 104 in the set 103 of binary color test. Based on the final scores 108 the user 300 may be assigned a category with the maximum value of the corresponding score 108, i.e. weighted sum.

A method according to an embodiment of the disclosure may comprise: a first step which may, for example, be performed during smartphone (device 100) initialization or during an additional calibration procedure including displaying a set 103 of binary color tests and obtaining user input information 109; and a second step which may be applied a color imaging pipeline of the device 100, wherein a standard observer CMF by may be replaced by a determined categorical CMF type 101. Said method may be performed by the device 100.

A user of the device 100 may be presented with a set 103 of binary color tests, wherein each binary color test 104 may consist of two pictures 107a, 107b. Further, each picture 107a, 107b may comprise a symbol on a background, wherein each picture 107a, 107b may be determined according to two categorical CMF types 101a, 101b. The number of binary tests 104 may be determined based on the severity of the metamerism effect failure for the display 102 on which the binary color tests 104 are presented.

The user 300 may select the picture 107a, 107b with a perceived color difference between the background and the symbol that is more pronounced. The user 300 may refuse the choice if, for example, the user 300 doesn't perceive a color contrast advantage of one of the pictures 107a, 107b over the other. The user 300 may visually compare the distinguishability of the stimulus against the background in the two images 107a, 107b of each binary color test 104.

Based on the automatic analysis of the user's 300 answers regarding the set 103 of binary color tests, a categorical CMF type 101 of the user 300 may be estimated, wherein a categorical CMF type 101 that is most similar to an individual CMF type 101 of the user 300 may be selected. Further, determining a categorical CMF type 101 of a user 300 may be based on one or more sub-weights. The sub-weights may represent the reliability of the binary color tests 104 and the reliability of the user's 300 answers.

In accordance with the identified categorical CMF type 101, a special test image may be formed and presented to the user 300 to verify the result of the test.

On the base of the estimated categorical CMF type 101 of the user 300, a new color imaging workflow to account for a personalized color reproduction may be realized, wherein the color workflow may be adjusted from a color workflow corresponding to a standard CMF type observer to a color workflow corresponding to the estimated categorical CMF type 101.

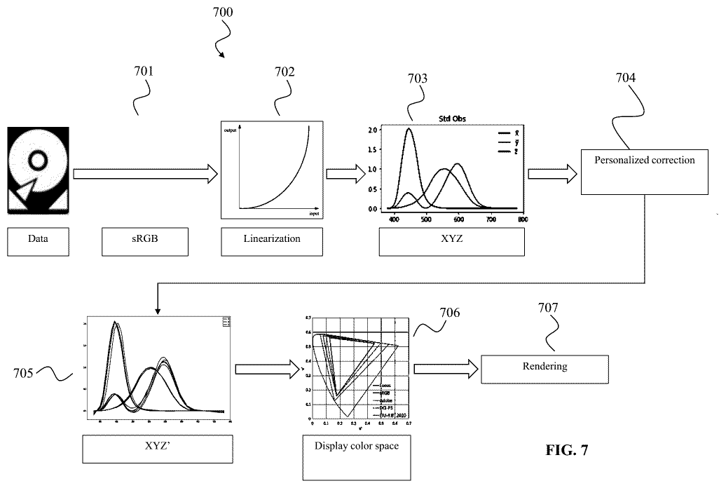

FIG. 7 shows a method 700 for personalized color imaging and/or adjusting the color imaging workflow of a device. The method 700 may be performed by the device 100. Imaging input data for visualizing pictures on a display 102 of the device 100 may be obtained 701 in a general device-independent format, for example, in sRGB. The imaging input data may undergo a standard correction procedure 702 including one or more of the following procedures: linearization (gamma correction), reference white point (D65) accounting, white balance, color transform and/or other procedures and may be converted 703 to a XYZ format.

Colors may be rendered on a display 102 by the display primaries of the display 102. The resulting spectrum emitted by the display 102 may be perceived by the user 300, wherein the perception of the user 300 depends on the individual CMFs of the user 300. CMF variations in people are caused by, for example, individual distributions of receptors on the retina. Further, based on input information 109 from the user 300 a categorical observer type of the user 300 may be estimated.

For personalized color correction 704, the imaging data may be converted from the XYZ format for a standard observer to a XYZ′ format 705 for a specific observer type, wherein the personal features of the user 300 may be taken into account. Further, the imaging data may be transformed to a display color space 706. The final data may again undergo standard correction procedures and may be rendered 707 and eventually displayed on the display 102.

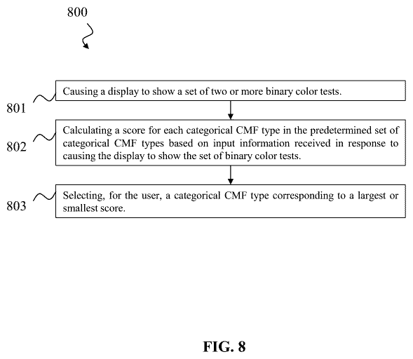

FIG. 8 shows a method 800 according to an embodiment of this disclosure. The method 800 may be performed by the device 100. The method 800 comprises a step 801 of causing a display to show a set of two or more binary color tests. Further, the method 800 comprises a step 802 of calculating a score for each categorical CMF type in the predetermined set of categorical CMF types based on input information received in response to causing the display to show the set of binary color tests. Further, the method 800 comprises a step 803 of selecting, for the user 300, a categorical CMF type corresponding to a largest or smallest score.

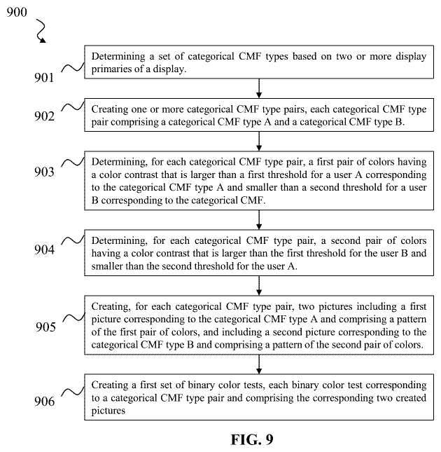

FIG. 9 shows a method 900 according to an embodiment of this disclosure. The method 900 may be performed by the device 200. The method 900 comprises a step 901 of determining a set of categorical CMF types based on two or more display primaries of a display. Further, the method 900 comprises a step 902 of creating one or more categorical CMF type pairs, each categorical CMF type pair comprising a categorical CMF type A and a categorical CMF type B. Further, the method 900 comprises a step 903 of determining, for each categorical CMF type pair, a first pair of colors having a color contrast that is larger than a first threshold for a user A corresponding to the categorical CMF type A and smaller than a second threshold for a user B corresponding to the categorical CMF type B. Further, the method 900 comprises a step 904 of determining, for each categorical CMF type pair, a second pair of colors having a color contrast that is larger than the first threshold for the user B and smaller than the second threshold for the user A. Further, the method 900 comprises a step 905 of creating, for each categorical CMF type pair, two pictures including a first picture corresponding to the categorical CMF type A and comprising a pattern of the first pair of colors, and including a second picture corresponding to the categorical CMF type B and comprising a pattern of the second pair of colors. Further, the method 900 comprises a step 906 of creating a first set of binary color tests, each binary color test corresponding to a categorical CMF type pair and comprising the corresponding two created pictures.

Experiments showed that an individually determined categorical CMF type according to an embodiment of this disclosure was chosen as a preferred CMF type by 88% of users, i.e. about 88% of users reported improvements in color contrast as a result of a color transform according to the individually determined categorical CMF type.

As a result of a color correction procedure for the corresponding categorical observer, the CIEDE2000 color difference increased by an average of 1.75 times, thus enabling users to distinguish colors that were indistinguishable before the color correction procedure.

Determining a categorical CMF type according to an embodiment of this disclosure may be based on color pairs with small CIEDE2000 color differences. Thus, the requirement on the number of different display primaries of a display may be low and/or reduced compared to conventional solutions.

The disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A device for estimating a categorical color matching function, CMF, type of a user, the device being configured to:
cause a display to show a set of two or more binary color tests;
wherein each binary color test corresponds to a pair of a categorical CMF type A and a categorical CMF type B of a predetermined set of categorical CMF types, and wherein each binary color test comprises:
a first picture for the categorical CMF type A of the pair, the first picture including a color contrast that is larger than a first threshold for a user A corresponding to the categorical CMF type A and smaller than a second threshold for a user B corresponding to the categorical CMF type B, and
a second picture for the categorical CMF type B of the pair, the second picture including a color contrast that is larger than the first threshold for the user B and smaller than the second threshold for the user A, wherein the second threshold is a discrimination threshold, and wherein the first threshold is equal to or larger than the second threshold;
the device being further configured to:
calculate a score for each categorical CMF type in the predetermined set of categorical CMF types based on input information received in response to causing the display to show the set of binary color tests; and
select, for the user, a categorical CMF type corresponding to a largest or smallest score.

2. The device according to claim 1, wherein the input information comprises for each binary color test one of: the first picture having been selected; the second picture having been selected; neither picture having been selected.

3. The device according to claim 2, wherein each score is calculated based on a weighted sum, and each summand in each weighted sum corresponds to one binary color test and is equal to a weight, if a picture was selected that corresponds to the categorical CMF type of the weighted sum, or is equal to zero otherwise.

4. The device according to claim 1, wherein the predetermined set of categorical CMF types is based on two or more display primaries of the display, or wherein of the predetermined set of categorical CMF types, each different categorical CMF type is paired once with each other categorical CMF type to form the categorical CMF type pairs.

5. The device according to claim 1, wherein for each picture the color contrast is:
maximized or increased for users of the corresponding categorical CMF type, and
minimized or reduced for users of the other categorical CMF type of the pair.

6. The device according to claim 1, wherein each picture comprises a color pair of two colors, and the set of binary color tests comprises respectively, for each categorical CMF type pair, M different binary color tests and 2*M different color pairs, wherein M is a positive integer larger than one.

7. The device according to claim 1, wherein the device is configured to cause the display to show each binary color test in the set two or more times.

8. The device according to claim 1, wherein each score is calculated based on a weighted sum, and wherein the device is configured to determine weights of each weighted sum based on one or more of the following weight sub-types:
priori weights;
individual posteriori weights;
general posteriori weights; and
statistical posteriori weights.

9. The device according to claim 7, wherein the device is further configured to determine one or more of:
individual posteriori weights, based on a reliability of the selections of the user for each binary color test, when causing the display to show each binary color test two or more times; or
general posteriori weights, based on an overall reliability of the selections of the user for all binary color tests, when causing the display to show each binary color test two or more times.

10. The device according to claim 8, wherein
the priori weights are determined for each picture, based on comparing a calculated color contrast of the respective picture to a calculated color contrast corresponding to the respective same categorical CMF type pair and categorical CMF type, and minimizing an objective function; and
the statistical posteriori weights are determined based on statistics of the reliability of the selections of a plurality of users for each binary color test, when the display is caused to show each binary color test two or more times.

11. The device according to any of the claim 8, wherein the weights of each weighted sum are equal to one of:
the individual posteriori weights;
the individual posteriori weights multiplied with a T-norm of the priori weights and the general posteriori weights; and
the individual posteriori weights multiplied with the statistical posteriori weights and a T-norm of the priori weights and the general posteriori weights.

12. The device according to claim 1, wherein the device is further configured to:
cause the to show a picture according to the selected categorical CMF type, and a picture according to a standard observer CMF type, and
obtain input information regarding which CMF type is selected.

13. The device according to claim 1, wherein the device is further configured to configure a color imaging pipeline according to the selected CMF type.

14. A device for creating a set of binary color tests, the device being configured to:
determine a set of categorical color matching function, CMF, types based on two or more display primaries of a display;
create one or more categorical CMF type pairs, each categorical CMF type pair comprising a categorical CMF type A and a categorical CMF type B, wherein out of the set of categorical CMF types each categorical CMF type is paired once with each other categorical CMF type;
determine, for each categorical CMF type pair, a first pair of colors having a color contrast that is larger than a first threshold for a user A corresponding to the categorical CMF type A and smaller than a second threshold for a user B corresponding to the categorical CMF type B, and a second pair of colors having a color contrast that is larger than the first threshold for the user B and smaller than the second threshold for the user A, wherein the second threshold is a discrimination threshold, and wherein the first threshold is equal to or larger than the second threshold;
create, for each categorical CMF type pair, two pictures including a first picture corresponding to the categorical CMF type A and comprising a pattern of the first pair of colors, and including a second picture corresponding to the categorical CMF type B and comprising a pattern of the second pair of colors; and
create a first set of binary color tests, each binary color test corresponding to a categorical CMF type pair and comprising the corresponding two created pictures.

15. The device according to claim 14, wherein for each picture the color contrast is:
maximized or increased for users of the corresponding categorical CMF type, and
minimized or reduced for users of the other categorical CMF type of the pair, by minimizing or reducing an objective function depending on the color contrast for users of both categorical CMF types of the pair.

16. The device according to claim 15, wherein reducing the objective function refers to:
a color contrast for users of both categorical CMF types of the pair resulting in at least an Nth smallest objective function output, N being a positive integer between two and ten; or
a color contrast for users of both categorical CMF types of the pair resulting in an objective function output that is below a predetermined threshold.

17. The device according to claim 14, wherein the device is further configured to create, for each categorical CMF type pair, one or more additional binary color tests,
wherein each picture of each additional binary color test comprises at least one different color compared to each picture corresponding to the respective same categorical CMF type pair, and
wherein the additional binary color tests and the first set of binary color tests define a second set of binary color tests.

18. The device according to claim 17, wherein the device is further configured to create one or more duplicates of each binary color test in the first set or second set of binary color tests.

19. The device according to claim 15, wherein the device is further configured to:
create priori weights for each picture by:
calculate a first color contrast of the respective color pair,
calculate a second color contrast of a color pair corresponding to the respective same categorical CMF type pair and categorical CMF type, and reduce the objective function, and
compare the first and second color contrast; and/or
create statistical posteriori weights based on statistics of the reliability of the selections of a plurality of users for each binary color test when each binary color test is included in the set two or more times.

20. A method of operating a device for estimating a categorical color matching function, CMF, type of a user, the method comprising:
causing a display to show a set of two or more binary color tests;
wherein each binary color test corresponds to a pair of a categorical CMF type A and a categorical CMF type B of a predetermined set of categorical CMF types, and wherein each binary color test comprises:
a first picture for the categorical CMF type A of the pair, the first picture including a color contrast that is larger than a first threshold for a user A corresponding to the categorical CMF type A and smaller than a second threshold for a user B corresponding to the categorical CMF type B, and
a second picture for the categorical CMF type B of the pair, the second picture including a color contrast that is larger than the first threshold for the user B and smaller than the second threshold for the user A, wherein the second threshold is a discrimination threshold, and wherein the first threshold is equal to or larger than the second threshold;
the method further comprising:
calculating a score for each categorical CMF type in the predetermined set of categorical CMF types based on input information received in response to causing the display to show the set of binary color tests; and
selecting, for the user, a categorical CMF type corresponding to a largest or smallest score.

21-23. (canceled)
